(19) United States
(12) Patent Application Publication
(10) Pub. No.: US 2023/0405674 A1
(43) Pub. Date: Dec. 21, 2023

(54) CONTINUOUS LOW-TEMPERATURE PLASMA POWDER TREATMENT AND BALL-MILLING PRODUCTION DEVICE AND METHOD THEREOF

(71) Applicant: South China University of Technology, Guangdong (CN)

(72) Inventors: Min ZHU, Guangdong (CN); Zhongchen LU, Guangdong (CN); Meiqin ZENG, Guangdong (CN); Liuzhang OUYANG, Guangdong (CN); Renzong HU, Guangdong (CN); Hui WANG, Guangdong (CN)

(21) Appl. No.: 18/035,603

(22) PCT Filed: Dec. 31, 2020
(86) PCT No.: PCT/CN2020/142595

§ 371 Date: May 5, 2023

(30) Foreign Application Priority Data
Nov. 6, 2020 (CN) 202011232156.4

(51) Int. Cl. B22F 9/04; B02C 17/10; B02C 17/14; B02C 21/00; B22F 9/14; C01B 32/21; C01B 32/949; C01G 41/02

(52) U.S. Cl. CPC B22F 9/04; B02C 17/10; B02C 17/14; B02C 21/00; B22F 9/14; C01B 32/21; C01B 32/949; C01G 41/02; B22F 2009/043; C01P 2002/88; C01P 2004/03; C01P 2004/62; C01P 2004/80

(57) ABSTRACT

Disclosed are a continuous low-temperature plasma powder treatment and ball-milling production device, and a method thereof. The device includes a powder circulating and conveying pipeline system (1), a ball mill (2), a low-temperature plasma discharge pipeline (3), a vacuum discharge system (4) and a controllable atmosphere system (5), where the powder circulating and conveying pipeline system (1) is sequentially connected to the ball mill (2) and the low-temperature plasma discharge pipeline (3) through pipelines; and the controllable atmosphere system (5) is connected to the powder circulating and conveying pipeline system (1). The powder circulating and conveying pipeline system (1) is used for circulating and conveying to-be-treated powder at a controllable air pressure and flow speed. On one hand, a double-dielectric barrier discharge structure is introduced in a powder conveying process to form the low-temperature plasma discharge pipeline (3), thereby realizing a plasma discharge treatment on a transfer material powder; and on the other hand, the ball mill (2) is introduced to perform ball-milling refining or alloying on a powder subjected to plasma discharge treatment, thereby treating the powder through a large-area, uniform and high-energy non-equilibrium plasma in cooperation with mechanical ball milling and being capable of being used for performing a surface circulating modification treatment on a conventional metal, macromolecule or oxide powder.

### TECHNICAL FIELD

The present invention belongs to the technical field of powdered material processing and powder metallurgy, relates to a plasma gas powder surface treatment and ball-milling technology, and in particular, relates to a continuous low-temperature plasma powder treatment and ball-milling production device.

### BACKGROUND

With the rapid development of new materials and intelligent manufacturing industries, the development of a low-cost, pollution-free and high-performance functional powder preparation technology is the key foundation in the fields of electronic information, mechanical manufacturing, biomedicine, national defense and military and the like. On one hand, a low-temperature plasma has sufficiently high-energy active substances to excite, ionize or break bonds of reactant molecules; and on the other hand, the low-temperature plasma will not be pyrolyzed or ablated by a treatment material and has a unique application value on a surface of a modified powder material.

The plasma is a fourth state of a material except a solid state, a gas state and a liquid state, and is composed of atoms, molecules, ions and free radicals with an equal number of positive and negative charges. The excitation of the plasma is mainly a quasi-neutral gas which is composed of a large number of positive and negative charged particles, electrons and neutral particles and free radicals generated by ionization of molecules when sufficient energy acts on the gas molecules and represents a collective behavior. Compared with a conventional physical and chemical synthesis method, a plasma method can avoid high temperature and long reaction time and can rapidly construct defects and doping on the surface of the material without destroying the nano-structure of the material, so that the structure, components, groups and wettability of the surface of the material are changed. The low-temperature plasma is widely applied to material synthesis and surface modification due to the characteristics of high electron temperature, low gas temperature and high energy. Dielectric barrier discharge is a common way of the low-temperature plasma, and is to fill a certain working gas between two discharge electrodes and add an insulating medium. When a sufficiently high alternating-current voltage is applied between the two electrodes, the gas between the electrodes will be broken down to discharge. Moreover, the dielectric barrier discharge can get rid of the constraint of a vacuum system required by a low-gas-pressure discharge plasma.

However, the mature technology of the current application of the low-temperature plasma to material synthesis and surface treatment mainly focuses on surface treatment of a macromolecular material and defect and doping construction on a surface of a catalytic material. For example, the energy of active particles in the low-temperature plasma generally approaches or exceeds the bond energy of carbon-carbon or other carbon-containing bonds; therefore, the plasma completely has sufficient energy to cause breakage or recombination of various chemical bonds in a polymer, and it is easy to introduce polar groups or active points in the surface of the macromolecular material. However, the low-temperature plasma is rarely applied to preparation and modification of metal materials, ceramic oxides and other materials. The current mature application technology is that CN 1718282 A and CN 2014108150933 respectively disclose a plasma-assisted high-energy ball-milling method, and an application method and device of a cold-field plasma discharge-assisted high-energy ball-milling powder. The above two patents mainly introduce how to improve and achieve the plasma discharge-assisted ball milling function and effect based on an ordinary ball mill. The materials used in the technology have been involved in elementary metal, hard metal, hydrogen storage alloy, a graphite-based electrode material, oxide ceramic, laser glass, an electrocatalyst, an infrared stealth sheet material, chlorinated solid waste material treatment and 3D printing powder, which initially shows the great value of the low-temperature plasma-assisted ball-milling technology. However, the main problem faced by the technology is that a ball-milling tank, as a discharge space of the plasma, is limited to that a conventional dielectric barrier discharge distance is not too large, so it is difficult for the volume of the ball-milling tank to exceed 10 liters. This is mainly because the space of the ball-milling tank is increased, a distance between an electrode rod and a pipe wall of the ball-milling tank of a grounding electrode will be increased, resulting in that the discharge distance of breaking down the ionized gas will be increased, and the larger the discharge distance is, the higher the discharge difficulty is; and for the volume of the ball-milling tank which is more than 10 liters, the discharge voltage will exceed 40 KV, and the life of the electrode rod is sharply reduced under the working condition of a high voltage. Therefore, the problem limits the application of the plasma-assisted ball-milling technology in a large-scale powder preparation industry.

In addition, CN 101239334 A and CN1011239336 A respectively disclose a plasma-assisted high-energy roller ball-milling device and a plasma-assisted stirring ball-milling device, which are mainly modified from a traditional roller and stirring ball mill and cannot solve the problem such as the limitation of the discharge distance on the space of the discharge ball-milling tank.

However, the co-construction of a plasma and ball-milling mechanical force can realize multiple beneficial preparation factors for a ball-milled powder material. Firstly, an electron temperature carried by a high-energy electron is extremely high, a micro-area of the powder is instantly heated during ball milling, when the powder leaves the plasma, the temperature is sharply reduced to generate a huge thermal stress, so that the powder is molten and decrepitated, and “rapid heating-rapid cooling” powder refining mechanism is generated; secondly, high-activity particles of the plasma and the ball-milled powder are subjected collision and adsorption, so that the surface activity of the material is improved, and the fresh surface and a large number of defects introduced by the ball-milling mechanical force further enhance the activity of the ball-milled powder, so that diffusion, phase change and chemical reaction can be easily performed; and finally, the powder is collided by a grinding ball while being heated by the plasma, deformation is performed at a certain temperature. Therefore, it is very meaningful how to apply the low-temperature plasma to the large-scale preparation or modified application of an industrial powder material.

EP1432964B1 2012 patent introduces an atmospheric pressure plasma jet and adopts a pipeline type single-dielectric barrier plasma discharge structure, that is, an aluminium oxide pipe with an inner diameter of 11 millimeters is coated with a metal layer to serve as a high-voltage electrode, and a grounded electrode with an outer diameter of 8 millimeters is inserted into the center of the aluminium oxide pipe; therefore, a discharge distance of the plasma is 1.5 millimeters, and the discharge space is small and limits the large-scale application.

A plasma generator generally applies a high-frequency electric field to a reaction gas environment under a negative pressure (vacuum), and the gas is ionized under the excitation of the high-frequency electric field to generate the plasma. These ions have high activity and the energy is sufficient to destroy almost all chemical bonds and cause the chemical reaction on the surface of the material, thereby changing the structure, components and groups of the surface of the material and obtaining a surface meeting the actual requirement. Moreover, the plasma has high reaction speed and high treatment efficiency, and modification only occurs on the surface of the material, so the property of the body material in the material is not affected, and it is an ideal surface modification method. Plasma surface modification has been widely applied to film-shaped, block-shaped and granular materials; moreover, different shapes of materials adopt different plasma treatment methods. For example, the film-shaped material (such as a film, a fabric, a non-woven fabric and a silk screen) can be packaged in rolls, so roll-to-roll batched treatment can be adopted; and the block-shaped materials can be placed one by one, so it is suitable for multi-layer plate electrode treatment. The plasma is less applied to treatment of powder particles, mainly focusing on surface treatment of a macromolecular material and defect and doping construction on a surface of a catalytic material.

If the large-scale application of the low-temperature plasma treating the powder material is extended to the fields of metal powder and oxide ceramic powder, the following problems are solved: (1) due to the powder accumulation and particle agglomeration in the powder plasma treatment process, the surfaces of particles that are not exposed in the plasma atmosphere are not treated and it is difficult to treat all the particles, resulting in incomplete and non-uniform particle treatment and poor treatment effect; (2) the controllable discharge intensity of energy of the plasma are realized, and since the bond energy of the macromolecular material is much lower than that of the metal and oxide materials, the conventional plasma for macromolecular material treatment has lower energy and is not suitable for the metal material and the oxide material; and (3) the general dielectric barrier plasma discharge or radio-frequency plasma discharge space is limited, so developing a large-area plasma discharge structure is a key to solving the problem of plasma large-scale preparation or powder treatment.

### SUMMARY

### Technical Solution

An objective of the present invention is to overcome the defects in the prior art, and provide a continuous low-temperature plasma powder treatment and ball-milling production device, and a method thereof.

An objective of the present invention is achieved through at least one of the following technical solutions.

A continuous low-temperature plasma powder treatment and ball-milling production device includes a powder circulating and conveying pipeline system, a ball mill, a low-temperature plasma discharge pipeline, a vacuum discharge system and a controllable atmosphere system, where the powder circulating and conveying pipeline system is sequentially connected to the ball mill and the low-temperature plasma discharge pipeline through pipelines; the low-temperature plasma discharge pipeline is connected to the powder circulating and conveying pipeline system; and the controllable atmosphere system is connected to the powder circulating and conveying pipeline system.

Further, the powder circulating and conveying pipeline system includes a feeding bin, a temporary storage bin, a feeding pipeline, a negative-pressure fan and a back-blowing system; the feeding bin is connected to the temporary storage bin; a bottom discharging outlet of the temporary storage bin is connected to a vacuum discharging system; the back-blowing system is arranged on the temporary storage bin; the back-blowing system is connected to the negative-pressure fan through a pipeline; and the negative-pressure fan is sequentially connected to the ball mill, the low-temperature plasma discharge pipeline and the temporary storage bin through pipelines.

The continuous low-temperature plasma powder treatment and ball-milling production device further includes a first pneumatic butterfly valve, a rotary discharging valve, a second pneumatic butterfly valve, a regulating gate valve, a third pneumatic butterfly valve and a silencer, where the first pneumatic butterfly valve is arranged between the feeding bin and the temporary storage bin; the rotary discharging valve is arranged at a discharging port of the temporary storage bin; the silencer is arranged at an outlet of the negative-pressure fan; and the third pneumatic butterfly valve, the regulating gate valve and the second pneumatic butterfly valve are arranged on a pipeline between the silencer and the ball mill.

Further, the low-temperature plasma discharge pipeline includes a feeding port, a discharging port, an external dielectric barrier layer, an internal dielectric barrier layer, an external high-voltage electrode, an internal ground electrode, a cooling liquid, a pipeline discharge gap and a pulse high-voltage power supply; the internal dielectric barrier layer forms a pipeline wall surface, the internal ground electrode is arranged in the pipeline, the internal ground electrode is hollow and is internally provided with the cooling liquid, and the external dielectric barrier layer is arranged on an outer wall surface of the internal ground electrode; and the external high-voltage electrode is arranged outside the internal dielectric barrier layer, and the pulse high-voltage power supply is connected between the external high-voltage electrode and the internal ground electrode.

Further, the controllable atmosphere system includes a working gas cylinder, a pressure-regulating valve, a pressure sensor, a fourth pneumatic butterfly valve and a dust remover; the working gas cylinder is respectively connected to outlet pipelines of the back-blowing system and the negative-pressure fan; the dust remover is arranged on a pipeline between the working gas cylinder and the back-blowing system; and the pressure-regulating valve, the pressure sensor and the pneumatic butterfly valve are arranged on a pipeline between outlets of the working gas cylinder and the negative-pressure fan.

A use method of the device includes the following steps: the powder circulating and conveying pipeline system circulates and conveys a to-be-treated material powder through a controllable gas pressure and a transfer speed; in this process, on one hand, a dielectric barrier discharge structure is introduced into some powder conveying pipelines to form the low-temperature plasma discharge pipeline and to realize plasma discharge treatment on a transfer material powder in the pipeline, and on the other hand, the ball mill is introduced in the powder pipeline conveying process, and the powder subjected to plasma discharge treatment is subjected to ball-milling refining or alloying; a powder transfer speed, a gas pressure and a discharge atmosphere are regulated and controlled by the controllable atmosphere system during the whole process, and the treated material powder enters the vacuum discharging system for recycling and packaging;

the powder circulating and conveying pipeline system operates under a negative-pressure condition;

the ball mill adopts vibration ball milling or roller ball milling;

the low-temperature plasma discharge pipeline utilizes powder conveying pipelines to construct a double-dielectric barrier discharge low-temperature plasma device and is matched with the pulse high-voltage power supply; and

the controllable atmosphere system is connected to the powder circulating and conveying pipeline system to provide a protective or reaction atmosphere required in a powder treatment and conveying process, the atmosphere includes argon, nitrogen, ammonia, hydrogen or oxygen, thereby achieving the effect of modifying a surface of a processed powder by a plasma through ionized discharge in the low-temperature plasma discharge pipeline.

According to the above use method, a transfer conveying distance of the material powder in a single circulation ranges from 6 meters to 20 meters, an internal diameter of a circulating pipeline ranges from 35 millimeters to 60 millimeters, a mass ratio of the material powder to the gas ranges from 5:1 to 12:1, a pressure of a transfer gas and a discharge gas ranges from −0.3 bar to −0.1 bar, and a transfer speed of the material powder and the gas ranges from 10 m/s to 15 m/s.

According to the above use method, in the powder circulating and conveying pipeline system, a powder is fed and enters the feeding bin, 10 L to 50 L of powder is fed at one time, the powder automatically enters the temporary storage bin under a working gas protection state through a feeding port of the feeding bin, a gas is subjected to solid-gas separation in the back-blowing system, the residual solid material powder enters the material circulating system through the rotary discharging valve and the feeding pipeline, is respectively subjected to mechanical ball milling through the ball mill and passes through the low-temperature plasma discharge pipeline from bottom to top under the action of a specific gas suspension force for surface treatment, then the material powder enters the temporary storage bin and the back-blowing system again for solid-gas separation, and the material powder is subjected to circulating treatment and enters the vacuum discharging system for packaging; the gas separated in the back-blowing system respectively passes through the negative-pressure fan, the silencer, the pneumatic butterfly valve, the regulating gate valve and the pneumatic butterfly valve, and the gas with pressure is fed to the material circulating system to provide power for the conveying of the material powder; and an inner diameter of the feeding pipeline ranges from 100 millimeters to 180 millimeters, and an inner diameter of other circulating pipelines ranges from 35 millimeters to 60 millimeters.

According to the above use method, in the low-temperature plasma discharge pipeline, the whole low-temperature plasma discharge pipeline ranges from 2 meters to meters long, the external dielectric barrier layer and the internal dielectric barrier layer are made of a quartz glass material or a high-purity zirconia ceramic material, and a distance between an outer wall of the internal dielectric barrier layer and an inner wall of the external dielectric barrier layer, that is a unilateral distance of the pipeline discharge gap is selected to range from 5 millimeters to 15 millimeters; and a peak-to-peak value of a pulse voltage of a power supply is 20 KV to 40 KV, a discharge frequency valve of the power supply ranges from 10 KHz to 40 KHz, and the cooling liquid is mainly used to cool and protect an electrode material to control a temperature of an electrode system below 150° C.

According to the above use method, in the controllable atmosphere system, by regulating the pressure of the working gas cylinder, the whole pipeline system is vacuumized, the required gas is replaced and the transfer speed of the material powder is regulated and controlled; and the gas cylinder realizes the work of the back-blowing system in the dust remover by setting a characteristic gas pressure and flow rate.

### Beneficial Effects

According to the present invention, the power circulating and conveying pipeline is combined with the double-dielectric barrier discharge plasma, a technology of controlling the intensity of the plasma in the pipeline is completed by using a double-dielectric barrier pipeline discharge structure, so that the stable synergistic action of the large-area, uniform and high-energy non-equilibrium plasma and downstream mechanical ball milling is achieved, and the technology has the following advantages:

firstly, a double-dielectric barrier discharge plasma can be generated at a near normal pressure and a normal pressure, and the gas pressure requirement of the operation atmosphere in the powder circulating and conveying pipeline is met; in this application, the pressure range of the transfer gas and the discharge gas is selected to be +0.3 bar to −0.1 bar; when the gas pressure is less than −0.3 bar, although the discharge intensity is high, the power transfer power is insufficient, the powder is distributed in the circulating pipeline non-uniformly, the power of the negative-pressure fan is increased sharply, and the heating quantity is increased sharply; and when the gas pressure is greater than −0.1 bar, the power transfer power is sufficient, the power is distributed in the circulating pipeline uniformly and the power of the negative-pressure fan is low, but the discharge intensity of the plasma in the low-temperature plasma discharge pipeline is insufficient, and a large amount of filamentary discharge or spark discharge will occur to endanger the life of the electrode.

Secondly, for the double-dielectric barrier discharge, the dielectric layer inhibits the infinite enhancement of micro-discharge, so that the dielectric barrier discharge cannot be converted into spark discharge or arc discharge, thereby ensuring that the plasma is not a thermal plasma with a strong material destructive power and preventing the electrode material from being burnt out.

Thirdly, the double-dielectric barrier discharge low-temperature plasma device is constructed by the power conveying pipeline, and the whole low-temperature plasma discharge pipeline ranges from 2 meters to 5 meters long, so that the powder conveying pipeline has the function of conveying material powder and also has the function of serving as a discharge plasma generator; and these solutions realize long-distance, large-area, uniform and stable glow discharge, have high utilization rate of the energy density of the plasma, avoid local high-intensity electric field breakdown, and achieve the plasma large-scale preparation and surface treatment technology of the material powder.

Fourthly, the double-dielectric barrier discharge can be uniformly spread on the surface of the dielectric layer; during the whole process, the powder flows in the circulating pipeline uniformly in a suspending manner; and in the process of passing through the low-temperature plasma discharge pipeline, all powder particles are completely immersed in the plasma, thereby treating all the powder particles.

Fifthly, the stable synergistic effect of the high-energy non-equilibrium plasma and mechanical ball milling can obviously reduce the reaction activation energy, refine crystal particles, greatly enhance the powder activity, improve the distribution uniformity of the particles, enhance the combination of an interface between matrixes, promote the diffusion of solid-solid and gas-solid ions and induce low-temperature reaction so as to improve all properties of the material, and is an energy-saving and efficient material preparation technology created based on a theory.

Sixthly, in the aspect of gas path system design, according to this application, parameters such as the components, pressure and powder circulation of the indoor atmosphere of the powder conveying pipeline are standardized, and the technology of controlling the gas discharge intensity is achieved together with the physical and chemical properties of the powder material.

Finally, the device has a function of “one machine with two purposes”, that is, in the operation process of the ball mill, the ball-milled powder is subjected to plasma treatment through the low-temperature plasma discharge pipeline, and the powder material is prepared by constructing mechanical ball milling and plasma multi-field coupling effect; and on the other hand, when mechanical ball milling stops operation, the whole device only depends on the low-temperature plasma discharge pipeline to perform a pure plasma surface modification function of the material powder.

### BRIEF DESCRIPTION OF DRAWINGS

FIG. 1 is a structural schematic diagram of a low-temperature plasma powder treatment and ball-milling production device according to the present invention;

FIG. 2 is a structural schematic diagram of a power circulating and conveying pipeline system and a controllable atmosphere system according to the present invention;

FIG. 3 is a structural schematic diagram of a low-temperature plasma discharge pipeline according to the present invention;

FIG. 4 is the morphology of Fe powder subjected to low-temperature plasma treatment and ball milling according to Embodiment 1;

FIG. 5a is a morphology SEM result of WO3-20 wt % C composite powder particles subjected to low-temperature plasma treatment and ball milling according to Embodiment 3;

FIG. 5b is a DSC result diagram of WO3-20 wt % C composite powder particles subjected to low-temperature plasma treatment and ball milling according to Embodiment 3; and

FIG. 6 is an SEM result diagram of synthesizing WC after performing heat preservation for 1 hour on WO3-20 wt % C composite powder subjected to low-temperature plasma treatment and ball milling in a vacuum sintering furnace at 1150° C.

In the drawings: power circulating and conveying pipeline system 1, ball mill 2, low-temperature plasma discharge pipeline 3, vacuum discharge system 4, controllable atmosphere system 5, feeding bin 11, first pneumatic butterfly valve 12, temporary storage bin 13, rotary discharging valve 14, feeding pipeline 15, second pneumatic butterfly valve 16, regulating gate valve 17, third pneumatic butterfly valve 18, silencer 19, negative-pressure fan 110, back-blowing system 111, feeding port 31, discharging port 32, external dielectric barrier layer 33, internal dielectric barrier layer 34, external high-voltage electrode 35, internal ground electrode 36, cooling liquid 37, pipeline discharge gap 38, pulse high-voltage power supply 39, working gas cylinder 51, pressure-regulating valve 52, pressure sensor 53, fourth pneumatic butterfly valve 54, dust remover 55.

### DETAILED DESCRIPTION OF EMBODIMENTS

Specific implementation of the present invention is described below in detail with reference to the accompanying drawings and specific embodiments, but the implementation and protection of the present invention are not limited to this.

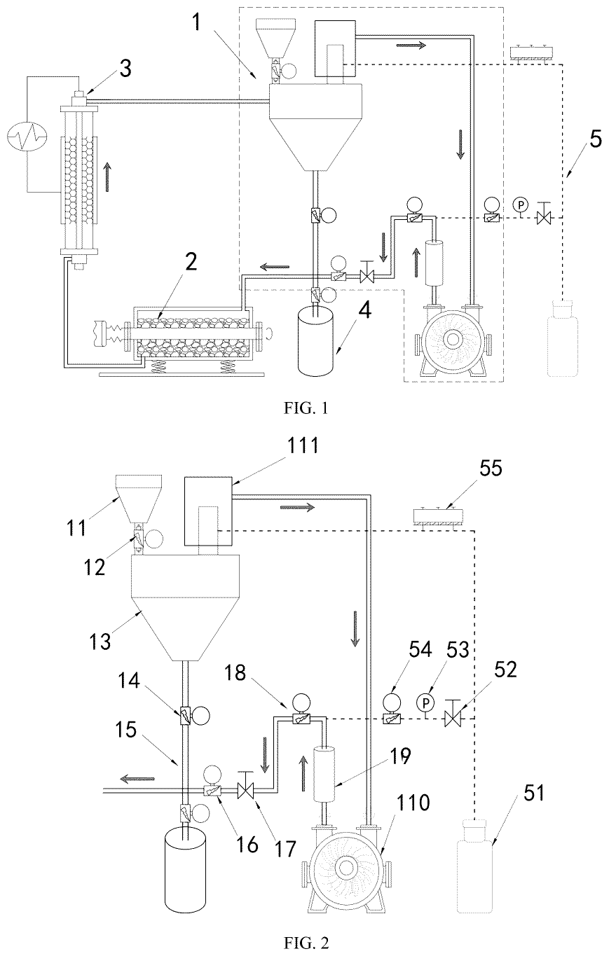

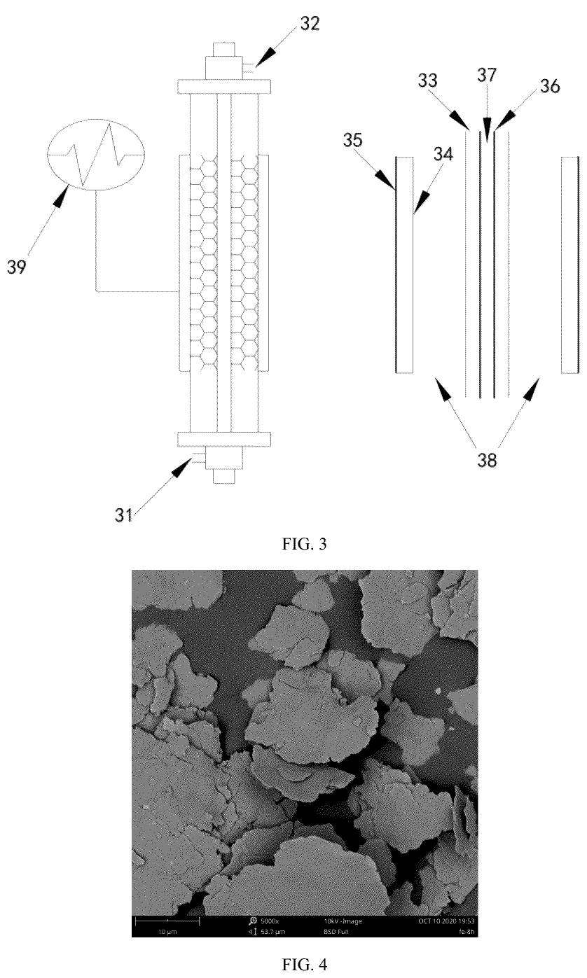

As shown in FIG. 1 to FIG. 3, a continuous low-temperature plasma powder treatment and ball-milling production device includes a powder circulating and conveying pipeline system 1, a ball mill 2, a low-temperature plasma discharge pipeline 3, a vacuum discharge system 4 and a controllable atmosphere system 5, where the powder circulating and conveying pipeline system 1 is sequentially connected to the ball mill 2 and the low-temperature plasma discharge pipeline 3 through pipelines; the low-temperature plasma discharge pipeline 3 is connected to the powder circulating and conveying pipeline system 1; and the controllable atmosphere system 5 is connected to the powder circulating and conveying pipeline system 1. The powder circulating and conveying pipeline system 1 includes a feeding bin 11, a temporary storage bin 13, a feeding pipeline 15, a negative-pressure fan 110 and a back-blowing system 111; the feeding bin 11 is connected to the temporary storage bin 13; a bottom outlet of the temporary storage bin 13 is connected to a vacuum discharging system 4; the back-blowing system 111 is arranged on the temporary storage bin 13; the back-blowing system 111 is connected to the negative-pressure fan 110 through a pipeline; and the negative-pressure fan 110 is sequentially connected to the ball mill 2, the low-temperature plasma discharge pipeline 3 and the temporary storage bin 13 through pipelines. The continuous low-temperature plasma powder treatment and ball-milling production device further includes a first pneumatic butterfly valve 12, a rotary discharging valve 14, a second pneumatic butterfly valve 16, a regulating gate valve 17, a third pneumatic butterfly valve 18 and a silencer 19, where the first pneumatic butterfly valve 12 is arranged between the feeding bin 11 and the temporary storage bin 13; the rotary discharging valve 14 is arranged at a discharging port of the temporary storage bin 13; the silencer 19 is arranged at an outlet of the negative-pressure fan 110; and the third pneumatic butterfly valve 18, the regulating gate valve 17 and the second pneumatic butterfly valve 16 are arranged on a pipeline between the silencer 19 and the ball mill 2. The low-temperature plasma discharge pipeline 3 includes a feeding port 31, a discharging port 32, an external dielectric barrier layer 33, an internal dielectric barrier layer 34, an external high-voltage electrode 35, an internal ground electrode 36, a cooling liquid 37, a pipeline discharge gap 38 and a pulse high-voltage power supply 39, where the internal dielectric barrier layer 34 forms a pipeline wall surface, the internal ground electrode 36 is arranged in the pipeline, the internal ground electrode 36 is hollow and is internally provided with the cooling liquid 37, and the external dielectric barrier layer 33 is arranged on an outer wall surface of the internal ground electrode 36; and the external high-voltage electrode 35 is arranged outside the internal dielectric barrier layer 34, and the pulse high-voltage power supply 39 is connected between the external high-voltage electrode 35 and the internal ground electrode 36. The controllable atmosphere system 5 includes a working gas cylinder 51, a pressure-regulating valve 52, a pressure sensor 53, a pneumatic butterfly valve 54 and a dust remover 55, where the working gas cylinder 51 is respectively connected to outlet pipelines of the back-blowing system 111 and the negative-pressure fan 110; the dust remover 55 is arranged on a pipeline between the working gas cylinder 51 and the back-blowing system 111; and the pressure-regulating valve 52, the pressure sensor 53 and the pneumatic butterfly valve 54 are arranged on a pipeline between outlets of the working gas cylinder 51 and the negative-pressure fan 110.

Firstly, a material powder is fed into the feeding bin through the powder circulating and conveying pipeline system, more than 10 L of material powder is fed at one time, and the material powder automatically enters the temporary bin under the protection state of argon through the feeding port of the feeding bin for solid-gas separation; the material powder is circulated and conveyed in a specific atmosphere in the system pipeline through negative-pressure conveying, is subjected to mechanical ball milling through the ball mill and passes through the low-temperature plasma discharge pipeline from bottom to top under a specific gas thrust for surface treatment; and after circulating treatment is performed for a certain time, the material powder enters the vacuum discharging system for packaging. During the whole process, the powder flows in the circulating pipeline uniformly in a suspending manner; and in the process of passing through the low-temperature plasma discharge pipeline, all powder particles are completely immersed in the plasma, thereby treating all the powder particles. Secondly, a double-dielectric barrier structure adopted in the present invention can effectively avoid the damage and breakdown of arc discharge to the electrode dielectric layer, can provide a discharge stability, and has high utilization rate of energy density of the plasma. Meanwhile, the peak-to-peak value of the pulse voltage of the power supply is 20 KV to 40 KV, and the discharge frequency valve of the power supply ranges from 10 KHz to 40 KHz, thereby ensuring high discharge energy and avoiding the problem of excessively high heating quantity of the electrode. Finally, according to the present invention, in the low-temperature plasma discharge pipeline, the whole low-temperature plasma discharge pipeline ranges from 2 meters to 5 meters long, the external dielectric barrier layer and the internal dielectric barrier layer are made of a quartz glass material or a high-purity zirconia ceramic material, and a distance between an outer wall of the internal dielectric barrier layer and an inner wall of the external dielectric barrier layer, that is a unilateral distance of the pipeline discharge gap is selected to range from 5 millimeters to 15 millimeters. A pipeline discharge technology of flowing powder is used to achieve a discharge structure of the long-distance and large-area plasma treated powder, which is a key to solving the plasma large-scale preparation or powder treatment.

### Embodiment 1

Step 1: a controllable atmosphere system was started to vacuumize a whole pipeline and a ball-milling cavity to below 1 Pa to be replaced with argon; secondly, a vibration ball mill and a powder circulating and conveying pipeline system were started; and finally, a low-temperature plasma discharge pipeline and a cooling system thereof were started.

Step 2: 15 kilograms of superfine Fe powder material was fed into a feeding bin at one time and entered a temporary storage bin under the protection state of the argon automatically through a feeding port of the feeding bin, a gas was subjected to solid-gas separation in a back-blowing system, and the residual solid material powder entered a material circulating system through a rotary discharging valve and a feeding pipeline, where an inner diameter of a powder circulating pipeline is 35 millimeters, a mass ratio of the material powder to the gas is 5:1, and a pressure of a transfer gas and a discharge gas is −0.3 bar.

Step 3: the to-be-treated superfine Fe powder was respectively subjected to mechanical ball milling through a vibration ball mill, passed through the low-temperature plasma discharge pipeline from bottom to top under the action of a specific gas suspension force for surface treatment, and then entered a temporary storage bin and the back-blowing system again for solid-gas separation, and after circulating treatment for a certain time, the material powder enters a vacuum discharging system for packaging, where the vibration ball mill adopts 1400 rpm, a gravitational acceleration of 10 g, an amplitude peak-to-peak value of 15 mm and a ball-to-material ratio of 100:1; in the low-temperature plasma discharge pipeline, a peak-to-peak value of a discharge voltage is 29 kV, a discharge current is 150 mA and a discharge frequency is 15 kHz; and an inner diameter of the feeding pipeline is 100 millimeters.

The result shows that the transfer speed of the superfine iron powder and the gas may be adjustable from 10 m/s to 13 m/s, and the powder is uniformly dispersed and flows in the pipeline; 8 hours after continuous work, in the low-temperature plasma discharge pipeline, discharge glow maintains a diffuse scattering state, and the temperature of the electrode does not exceed 150° C.; and the temperature of the negative-pressure fan is close to 80° C., and the transfer conveying distance of the material powder in a single circulation is 6 meters. The prepared Fe powder has a sheet-like structure of about 30 microns, as shown in FIG. 4. It shows that the Fe powder with the sheet-like structure can be effectively prepared by coordinating the negative-pressure argon plasma with ball milling, which is mainly because the high discharge intensity of the negative-pressure argon plasma improves the “electro-thermal” coupling effect, the heat effect of the plasma makes the local temperature of the ball-milled powder higher than the recrystallization temperature of Fe, thermal processing occurs in the ball milling process, and the processing hardening effect is weakened; and the electroplastic effect improves the plasticity of the powder, so that the powder is further extended from a thin block to a thinner sheet, and then is broken and refined into a fine sheet under the action of the strong mechanical force of a grinding ball.

### Embodiment 2

Step 1: a controllable atmosphere system was started to vacuumize a whole pipeline and a ball-milling cavity to below 1 Pa to be replaced with argon; secondly, a powder circulating and conveying pipeline system was started; and finally, a low-temperature plasma discharge pipeline and a cooling system thereof were started.

Step 2: 15 kilograms of superfine Fe powder material was fed into a feeding bin at one time and entered a temporary storage bin under the protection state of the argon automatically through a feeding port of the feeding bin, a gas was subjected to solid-gas separation in a back-blowing system, and the residual solid material powder entered a material circulating system through a rotary discharging valve and a feeding pipeline, where an inner diameter of a powder circulating pipeline is 60 millimeters, a mass ratio of the material powder to the gas is 12:1, and a pressure of a transfer gas and a discharge gas is −0.1 bar.

Step 3: the to-be-treated superfine Fe powder respectively passed through a vibration ball mill, passed through the low-temperature plasma discharge pipeline from bottom to top under the action of a specific gas suspension force for surface treatment, and then entered a temporary storage bin and the back-blowing system again for solid-gas separation, and after circulating treatment for a certain time, the material powder enters a vacuum discharging system for packaging, where the vibration ball mill adopts no-load at 0 rpm; in the low-temperature plasma discharge pipeline, a peak-to-peak value of a discharge voltage is 29 kV, a discharge current is 150 mA and a discharge frequency is 15 kHz; and an inner diameter of the feeding pipeline is 180 millimeters.

The result shows that the transfer speed of the superfine iron powder and the gas may be adjustable from 10 m/s to 15 m/s, and the powder is uniformly dispersed and flows in the pipeline; 8 hours after continuous work, in the low-temperature plasma discharge pipeline, partially filamentary discharge occurs in discharge glow, and the temperature of the electrode does not exceed 150° C.; and the temperature of the negative-pressure fan is less than 70° C., and the transfer conveying distance of the material powder in a single circulation is 20 meters.

The above treatment only modifies the surface of the superfine Fe powder, and the superfine Fe powder modified by the discharge plasma serves as a main casing metal of a diamond grinding block, so that the wetting state of the diamond on the casing can be obviously improved, the binding strength of the diamond and the casing can be enhanced, and solid-phase sintering of the casing Fe powder can be improved.

### Embodiment 3

Step 1: a controllable atmosphere system was started to vacuumize a whole pipeline and a ball-milling cavity to below 1 Pa to be replaced with argon; secondly, a vibration ball mill and a powder circulating and conveying pipeline system were started; and finally, a low-temperature plasma discharge pipeline and a cooling system thereof were started.

Step 2: 8 kilograms of WO3 and graphite were mixed according to a carbon proportion of 20 percent by mass, the mixed powder was subjected to pre-ball milling in a vibration ball mill for 1 hour, was fed into a feeding bin at one time and entered a temporary storage bin under the protection state of the argon automatically through a feeding port of the feeding bin, a gas was subjected to solid-gas separation in a back-blowing system, and the residual solid material powder entered a material circulating system through a rotary discharging valve and a feeding pipeline, where an inner diameter of a powder circulating pipeline is 50 millimeters, a mass ratio of the material powder to the gas is 10:1, and a pressure of a transfer gas and a discharge gas is −0.2 bar.

Step 3: the to-be-treated WO3 and graphite mixed powder was respectively subjected to mechanical ball milling through a vibration ball mill, passed through the low-temperature plasma discharge pipeline from bottom to top under the action of a specific gas suspension force for surface treatment, and then entered a temporary storage bin and the back-blowing system again for solid-gas separation, and after circulating treatment for a certain time, the material powder enters a vacuum discharging system for packaging, where the vibration ball mill adopts 1400 rpm, a gravitational acceleration of 10 g, an amplitude peak-to-peak value of 15 mm and a ball-to-material ratio of 100:1; in the low-temperature plasma discharge pipeline, a peak-to-peak value of a discharge voltage is 29 kV, a discharge current is 150 mA and a discharge frequency is 15 kHz; and an inner diameter of the feeding pipeline is 150 millimeters.

The result shows that the transfer speed of the WO3-C mixed powder and the gas may be adjustable from 10 m/s to 15 m/s, and the powder is uniformly dispersed and flows in the pipeline; 8 hours after continuous work, in the low-temperature plasma discharge pipeline, discharge glow maintains a diffuse scattering state, and the temperature of the electrode does not exceed 150° C.; and the temperature of the negative-pressure fan is close to 70° C., and the transfer conveying distance of the material powder in a single circulation is 10 meters.

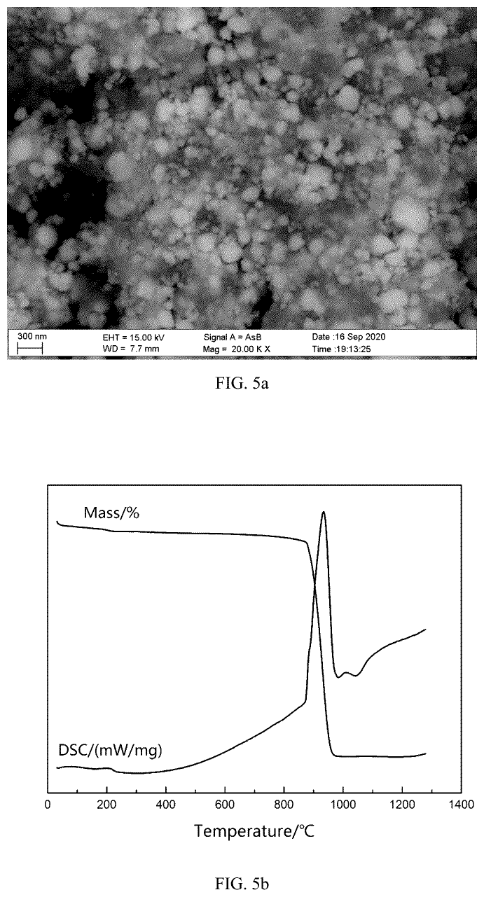

Through the test on the WO3-20 wt % C composite powder subjected to low-temperature plasma treatment and ball milling by SEM and DSC, it is found that 100 to 200 nm of WO3 is coated with graphite in a uniform scattering manner to form a good interface combination, as shown in FIG. 5a; and the DSC test result shows that the temperature of WO3 and C in-situ reduction reaction is reduced from more than 1000° C. after ordinary ball milling to 900° C., as shown in FIG. 5b. The temperature of the WO3 and C in-situ reduction reaction obviously affects the particle size of the synthesized WC, because the higher the WO3 and C in-situ reduction reaction temperature is, the longer the heat preservation time, and the easier it is to cause WC to grow. Therefore, it is very important to reduce the temperature of the in-situ reduction reaction in order to prepare nanoscale WC powder.

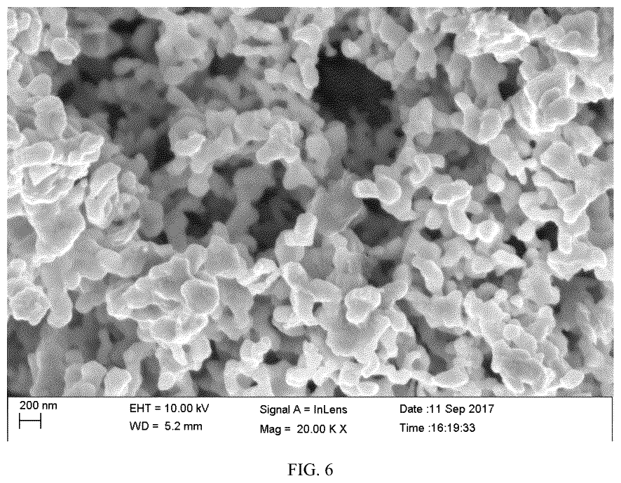

After the powder is subjected to heat preservation in a 1150° C. vacuum sintering furnace for 1 hour, the grain size of the synthesized WC is 100 nm to 200 nm, as shown in FIG. 6. The preparation of a superfine grain WC—Co hard alloy prepared from WO3, C and Co by an in-situ reduction method has the advantages of low price and short process flow, and has an important industrial application value. The key step of preparing the superfine grain WC—Co hard ally by the in-situ reduction method is to synthesize the superfine WC powder only containing a single phase because the powder may adsorb oxygen to lose carbon in the ball milling, reaction and sintering processes, resulting in that the carbon ratio is difficult to control. Therefore, the high-performance superfine WC powder can be synthesized by a continuous low-temperature plasma treatment and ball-milling production device.

### Embodiment 4

Step 1: a controllable atmosphere system was started to vacuumize a whole pipeline and a ball-milling cavity to below 1 Pa to be replaced with argon; secondly, a powder circulating and conveying pipeline system was started; and finally, a low-temperature plasma discharge pipeline and a cooling system thereof were started.

Step 2: 2 kilograms of polyethylene powder material was fed into a feeding bin at one time and entered a temporary storage bin under the protection state of the argon automatically through a feeding port of the feeding bin, a gas was subjected to solid-gas separation in a back-blowing system, and the residual solid material powder entered a material circulating system through a rotary discharging valve and a feeding pipeline, where an inner diameter of a powder circulating pipeline is 60 millimeters, a mass ratio of the material powder to the gas is 5:1, and a pressure of a transfer gas and a discharge gas is −0.3 bar.

Step 3: the to-be-treated polyethylene powder respectively passed through a vibration ball mill, passed through the low-temperature plasma discharge pipeline from bottom to top under the action of a specific gas suspension force for surface treatment, and then entered a temporary storage bin and the back-blowing system again for solid-gas separation, and after circulating treatment for a certain time, the material powder enters a vacuum discharging system for packaging, where the vibration ball mill adopts no-load at 0 rpm; in the low-temperature plasma discharge pipeline, a peak-to-peak value of a discharge voltage is 20 kV, a discharge current is 100 mA and a discharge frequency is 11 KHz; and an inner diameter of the feeding pipeline is 180 millimeters.

The result shows that the transfer speed of the graphite powder and the gas may be adjustable from 10 m/s to 15 m/s, and the powder is uniformly dispersed and flows in the pipeline; 8 hours after continuous work, in the low-temperature plasma discharge pipeline, partially filamentary discharge occurs in discharge glow, and the temperature of the electrode does not exceed 150° C.; and the temperature of the negative-pressure fan is less than 70° C., and the transfer conveying distance of the material powder in a single circulation is 10 meters.

The above treatment only modifies the surface of the polyethylene powder, the wettability of the polyethylene powder modified by the discharge plasma in deionized water is obviously improved, all the untreated polyethylene powder is basically suspended on a water surface, and most of the polyethylene powder subjected to plasma treatment can be rapidly settled in the deionized water. The experimental process achieves the same effect in the surface treatment process of graphite powder.

1. A continuous low-temperature plasma powder treatment and ball-milling production device, comprising a powder circulating and conveying pipeline system (1), a ball mill (2), a low-temperature plasma discharge pipeline (3), a vacuum discharge system (4) and a controllable atmosphere system (5), wherein the powder circulating and conveying pipeline system (1) is sequentially connected to the ball mill (2) and the low-temperature plasma discharge pipeline (3) through pipelines; the low-temperature plasma discharge pipeline (3) is connected to the powder circulating and conveying pipeline system (1); and the controllable atmosphere system (5) is connected to the powder circulating and conveying pipeline system (1).

2. The continuous low-temperature plasma powder treatment and ball-milling production device according to claim 1, wherein the powder circulating and conveying pipeline system (1) comprises a feeding bin (11), a temporary storage bin (13), a feeding pipeline (15), a negative-pressure fan (110) and a back-blowing system (111); the feeding bin (11) is connected to the temporary storage bin (13); a bottom discharging outlet of the temporary storage bin (13) is connected to a vacuum discharging system (4); the back-blowing system (111) is arranged on the temporary storage bin (13); the back-blowing system (111) is connected to the negative-pressure fan (110) through a pipeline; and the negative-pressure fan (110) is sequentially connected to the ball mill (2), the low-temperature plasma discharge pipeline (3) and the temporary storage bin (13) through pipelines.

3. The continuous low-temperature plasma powder treatment and ball-milling production device according to claim 2, further comprising a first pneumatic butterfly valve (12), a rotary discharging valve (14), a second pneumatic butterfly valve (16), a regulating gate valve (17), a third pneumatic butterfly valve (18) and a silencer (19), wherein the first pneumatic butterfly valve (12) is arranged between the feeding bin (11) and the temporary storage bin (13); the rotary discharging valve (14) is arranged at a discharging port of the temporary storage bin (13); the silencer (19) is arranged at an outlet of the negative-pressure fan (110); and the third pneumatic butterfly valve (18), the regulating gate valve (17) and the second pneumatic butterfly valve (16) are arranged on a pipeline between the silencer (19) and the ball mill (2).

4. The continuous low-temperature plasma powder treatment and ball-milling production device according to claim 1, wherein the low-temperature plasma discharge pipeline (3) comprises a feeding port (31), a discharging port (32), an external dielectric barrier layer (33), an internal dielectric barrier layer (34), an external high-voltage electrode (35), an internal ground electrode (36), a cooling liquid (37), a pipeline discharge gap (38) and a pulse high-voltage power supply (39); the internal dielectric barrier layer (34) forms a pipeline wall surface, the internal ground electrode (36) is arranged in the pipeline, the internal ground electrode (36) is hollow and is internally provided with the cooling liquid (37), and the external dielectric barrier layer (33) is arranged on an outer wall surface of the internal ground electrode (36); and the external high-voltage electrode (35) is arranged outside the internal dielectric barrier layer (34), and the pulse high-voltage power supply (39) is connected between the external high-voltage electrode (35) and the internal ground electrode (36).

5. The continuous low-temperature plasma powder treatment and ball-milling production device according to claim 1, wherein the controllable atmosphere system (5) comprises a working gas cylinder (51), a pressure-regulating valve (52), a pressure sensor (53), a fourth pneumatic butterfly valve (54) and a dust remover (55); the working gas cylinder (51) is respectively connected to outlet pipelines of the back-blowing system (111) and the negative-pressure fan (110); the dust remover (55) is arranged on a pipeline between the working gas cylinder (51) and the back-blowing system (111); and the pressure-regulating valve (52), the pressure sensor (53) and the pneumatic butterfly valve (54) are arranged on a pipeline between outlets of the working gas cylinder (51) and the negative-pressure fan (110).

6. A use method of the device according to claim 1, wherein the powder circulating and conveying pipeline system (1) circulates and conveys to-be-treated material powder through a controllable gas pressure and a transfer speed; in this process, on one hand, a dielectric barrier discharge structure is introduced into some powder conveying pipelines to form the low-temperature plasma discharge pipeline (3) and to realize plasma discharge treatment on a transfer material powder in the pipeline, and on the other hand, the ball mill (2) is introduced in the powder pipeline conveying process, and the powder subjected to plasma discharge treatment is subjected to ball-milling refining or alloying; a powder transfer speed, a gas pressure and a discharge atmosphere are regulated and controlled by the controllable atmosphere system (5) during the whole process, and the treated material powder enters the vacuum discharging system (4) for recycling and packaging;
the powder circulating and conveying pipeline system (1) operates under a negative-pressure condition;
the ball mill (2) adopts vibration ball milling or roller ball milling;
the low-temperature plasma discharge pipeline (3) utilizes powder conveying pipelines to construct a double-dielectric barrier discharge low-temperature plasma device and is matched with the pulse high-voltage power supply;
the controllable atmosphere system (5) is connected to the powder circulating and conveying pipeline system to provide a protective or reaction atmosphere required in a powder treatment and conveying process, thereby achieving the effect of modifying a surface of a processed powder by a plasma through ionized discharge in the low-temperature plasma discharge pipeline; and the atmosphere comprises argon, nitrogen, ammonia, hydrogen or oxygen.

7. The use method of the device according to claim 6, wherein a transfer conveying distance of the material powder in a single circulation ranges from 6 meters to 20 meters, an internal diameter of a circulating pipeline ranges from 35 millimeters to 60 millimeters, a mass ratio of the material powder to the gas ranges from 5:1 to 12:1, a pressure of a transfer gas and a discharge gas ranges from −0.3 bar to −0.1 bar, and a transfer speed of the material powder and the gas ranges from 10 m/s to 15 m/s.

8. The use method of the device according to claim 6, wherein in the powder circulating and conveying pipeline system (1), a powder is fed and enters the feeding bin (11), 10 L to 50 L of powder is fed at one time, the powder automatically enters the temporary storage bin (13) under a working gas protection state through a feeding port of the feeding bin, a gas is subjected to solid-gas separation in the back-blowing system (111), the residual solid material powder enters the material circulating system through the rotary discharging valve (14) and the feeding pipeline (15) and is respectively subjected to mechanical ball milling through the ball mill (2) and passes through the low-temperature plasma discharge pipeline (3) from bottom to top under the action of a specific gas suspension force for surface treatment, then the material powder enters the temporary storage bin (13) and the back-blowing system (111) again for solid-gas separation, and the material powder is subjected to circulating treatment and enters the vacuum discharging system (4) for packaging; the gas separated in the back-blowing system (111) respectively passes through the negative-pressure fan (110), the silencer (19), the pneumatic butterfly valve (18), the regulating gate valve (17) and the pneumatic butterfly valve (16), and pressurized gas is fed to the material circulating system to provide power for the conveying of the material powder; and an inner diameter of the feeding pipeline (15) ranges from 100 millimeters to 180 millimeters, and an inner diameter of other circulating pipelines ranges from 35 millimeters to 60 millimeters.

9. The use method according to claim 6, wherein in the low-temperature plasma discharge pipeline (3), the whole low-temperature plasma discharge pipeline ranges from 2 meters to 5 meters long, the external dielectric barrier layer (33) and the internal dielectric barrier layer (34) are made of a quartz glass material or a high-purity zirconia ceramic material, and a distance between an outer wall of the internal dielectric barrier layer and an inner wall of the external dielectric barrier layer, that is a unilateral distance of the pipeline discharge gap (38) is selected to range from 5 millimeters to 15 millimeters; and a peak-to-peak value of a pulse voltage of a power supply ranges from 20 KV to 40 KV, a discharge frequency valve of the power supply ranges from 10 KHz to 40 KHz, and the cooling liquid (37) is mainly used to cool and protect an electrode material to control a temperature of an electrode system below 150° C.

10. The use method according to claim 6, wherein in the controllable atmosphere system (5), by regulating the pressure of the working gas cylinder, the whole pipeline system is vacuumized, the required gas is replaced and the transfer speed of the material powder is regulated and controlled; and the gas cylinder realizes the work of the back-blowing system (111) in the dust remover (56) by setting a characteristic gas pressure and flow rate.

11. The use method according to claim 7, wherein in the controllable atmosphere system (5), by regulating the pressure of the working gas cylinder, the whole pipeline system is vacuumized, the required gas is replaced and the transfer speed of the material powder is regulated and controlled; and the gas cylinder realizes the work of the back-blowing system (111) in the dust remover (56) by setting a characteristic gas pressure and flow rate.

12. The use method according to claim 8, wherein in the controllable atmosphere system (5), by regulating the pressure of the working gas cylinder, the whole pipeline system is vacuumized, the required gas is replaced and the transfer speed of the material powder is regulated and controlled; and the gas cylinder realizes the work of the back-blowing system (111) in the dust remover (56) by setting a characteristic gas pressure and flow rate.

13. The use method according to claim 9, wherein in the controllable atmosphere system (5), by regulating the pressure of the working gas cylinder, the whole pipeline system is vacuumized, the required gas is replaced and the transfer speed of the material powder is regulated and controlled; and the gas cylinder realizes the work of the back-blowing system (111) in the dust remover (56) by setting a characteristic gas pressure and flow rate.
